(19) United States
(12) Patent Application Publication
(10) Pub. No.: US 2025/0165822 A1
(43) Pub. Date: May 22, 2025

(54) SYSTEMS AND METHODS FOR PRE-SELECTING A MACHINE LEARNING MODEL BASED ON DETERMINED DATASET CHARACTERISTICS

(71) Applicant: Capital One Services, LLC, McLean, VA (US)

(72) Inventors: Vannia GONZALEZ MACIAS, Glen Allen, VA (US); Justin ESSERT, Richmond, VA (US); Pratik GANDHI, Vernon Hills, IL (US)

(73) Assignee: Capital One Services, LLC, McLean, VA (US)

(21) Appl. No.: 18/516,555

(22) Filed: Nov. 21, 2023

(51) Int. Cl. G06N 7/01

(52) U.S. Cl. CPC G06N 7/01

(57) ABSTRACT

Pre-selecting a machine learning model based on determined dataset characteristics may be facilitated. In some embodiments, a time-series dataset may be received by a system. Based on the time-series dataset, the system generates a periodogram to determine power frequencies of a set of frequencies of the time-series dataset. The system may then determine an asymptotic p-value based on the periodogram, where the asymptotic p-value indicates a probability value that a seasonal cycle is part of the time-series dataset. In response to a comparison between the asymptotic p-value and a threshold p-value indicating that the asymptotic p-value fails to exceed the threshold p-value, the system determines a seasonality cycle of the time-series dataset. The system then generates, for display, on a user interface, a recommendation for a machine learning model based on (i) the seasonality cycle of the time-series dataset and (ii) the power frequencies.

### BACKGROUND

In recent years, the use of artificial intelligence, including, but not limited to, machine learning, deep learning, etc. (referred to collectively herein as “artificial intelligence models,” “machine learning models,” or simply “models”), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming, and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. This requirement for specialized knowledge to design, program, and integrate artificial intelligence-based solutions is often rooted in “knowing” the dataset (e.g., to be inputted) and parameters related to the dataset to design an artificial intelligence model to process input data. However, given the large volumes of datasets and the obscure nature of datasets, determining dataset parameters for designing an artificial intelligence model is currently infeasible and only relies on properly labeled datasets. These technical challenges may present an inherent problem with attempting to use existing methods to select artificial intelligence models that are configured to process given datasets.

### SUMMARY

Methods and systems are described herein for novel uses and/or improvements to artificial intelligence or machine learning model applications. As one example, methods and systems are described herein for pre-selecting a machine learning model based on determined dataset characteristics.

Existing machine learning model selection processes currently rely on the manual extraction of dataset characteristics based on the mere opinion of computer scientists. For example, as computer scientists discover a problem they would like to solve using a machine learning model (or other artificial intelligence model), computer scientists develop a hypothesis as to (i) which dataset to use to extract information from and (ii) which machine learning model may be best suited for extracting such information. Of the available machine learning models that are in existence, some machine learning models may perform better than others when processing a certain type of dataset. Moreover, some machine learning models cannot process particular types of datasets at all without being provided characteristics of the dataset.

While computer scientists may manually extract such characteristics, this manual characteristic extraction process is a mixture of guesses and applying mathematical/statistical reasoning processes on datasets to extract some level of characteristics of the data. For instance, in the context of time-series datasets, many machine learning models available to process such unique data are unable to process such datasets without predisposed knowledge of the dataset such as (i) whether a seasonality cycle exists within the dataset, (ii) the period of the seasonality cycle, and (iii) the seasonality type (e.g., multiplicative or additive). Without these characteristics, the machine learning models are simply prevented from processing the time-series dataset. Moreover, if inaccurate characteristics are provided to the machine learning model, the machine learning model provides inaccurate predictions, thereby causing an increase in wasted computational resources (e.g., computer processing and memory resources).

Moreover, during a manual characteristic extraction process, computer scientists may rely on inadequate and infeasible statistical methodologies. For example, existing systems currently rely on Bartlett's periodogram (1948) and Fisher's test (1929) to determine the periodicity of a time-series dataset. However, Bartlett's periodogram suffers from window-length sensitivity when computing the periodogram (e.g., too small of a window length results in poor frequency resolution and too great of a window length may smooth over important spectral features), which causes a loss of information when generating Bartlett's periodogram, thereby leading to inaccurate results. Additionally, Bartlett's method relies on a segmented, non-overlapping, window-driven approach when generating the periodogram based on the time-series dataset, thereby leading to discarded or unconsidered data segments, causing inaccurate spectral estimations.

When applying Fisher's test to Bartlett's periodogram, Fisher's test lacks scalability as Fisher's test is not suitable for large datasets (e.g., having a dimension that is greater than 20 dimensions) and is limited to small dimensional datasets. For example, Fisher's test is computationally expensive and as the number of dimensions increase, the amount of computations to obtain a result increases exponentially. Additionally, Fisher's test is hypersensitive to small cell counts (e.g., countable quantities of dimensional data) which are inherent in large datasets, thereby producing significant results for extracted dimensional associations which are not practically meaningful. Moreover, due to small cell counts being inherent in large datasets, Fisher's test cannot accurately obtain reliable results (e.g., yields unstable or unreliable p-values) based on large datasets as low cell counts indicate data sparsity, thereby causing inaccurate seasonality cycle extraction and periodicity extraction. Therefore, although the applications of Bartlett's periodogram and Fisher's test may produce some characteristics of the time-series dataset, such methodology is error prone, computationally expensive, and dimensionally limited, thereby inadequate for producing accurate and robust characteristics of large time-series datasets.

Moreover, merely training a machine learning model to determine dataset characteristics is not a suitable approach. For instance, as machine learning models include an expected error, even if one were to train a machine learning model to determine dataset characteristics prior to selecting another machine learning model to process the dataset, such determined dataset characteristics may be error prone. This further exacerbates the errors that may be realized when determining which machine learning model to select to process the dataset as the dataset characteristics may include one or more errors. Furthermore, training a machine learning model to determine such dataset characteristics is a computationally expensive process, which may cause computational lagging and waste valuable computational resources (e.g., as the determined dataset characteristics are error prone).

To overcome these technical deficiencies, methods and systems disclosed herein provide improvements for pre-selecting a machine learning model based on determined dataset characteristics. For instance, by determining dataset characteristics of large datasets, the system may select a machine learning model based on the determined dataset characteristics to process the dataset and produce accurate and reliable machine learning model-derived predictions. For example, by first generating a periodogram (e.g., a Welch periodogram) based on a received time-series dataset to determine power frequencies of the time-series dataset, the system may reduce time-series dataset variance, improve frequency resolution, reduce noise, and smooth spectral estimation, thereby causing more accurate and robust seasonality cycle and periodicity of the seasonality within the time-series dataset to be extracted from the time-series dataset. Moreover, by using a Welch periodogram technique, the time-series dataset may be broken down into individual segments (e.g., based on the dimensions of the dataset) which may be individually processed using overlapping windows, thereby improving computational efficiency (e.g., caused by breaking up the dataset into segments that may be processed individually as opposed to all at once) while ensuring data consistency (e.g., mitigating a loss in data as compared to existing methods).

Second, by determining asymptotic p-values based on the Welch periodogram (e.g., using a spectral decomposition technique using orthonormal functions), the system may determine a seasonality cycle within the time-series dataset (e.g., based on a comparison between the asymptotic p-value satisfying a threshold asymptotic p-value). For example, the seasonality cycle may be an indication as to whether seasonality exists within the time-series dataset which may be extracted for configuring a machine learning model. The benefit of using a spectral decomposition technique using orthonormal functions as opposed to Fisher's test or other existing methods is that such orthonormal functions enable better frequency domain analysis (e.g., thereby leading to more accurate seasonality cycle extraction and periodicity extraction) and ability to separate noise within the data (e.g., by decomposing the periodogram/time-series dataset into frequency-based components), thereby leading to more accurate and robust extracted dataset characteristics.

Third, the system may provide a recommendation for the machine learning model based on the (i) seasonality cycle of the time-series dataset (e.g., whether the time-series dataset indicates a seasonal cycle) and (ii) the power frequencies of the time-series dataset. For instance, the system may select a machine learning model from a set of machine learning models that are configured to process time-series datasets having the determined seasonality cycle and power frequencies. By doing so, the system may select a machine learning model that is specifically keyed to a given dataset based on determined dataset characteristics, prior to providing the machine learning model the given dataset-thereby enabling more accurate and robust machine learning model-derived predictions to be generated based on such dataset.

In some aspects, the system may receive a time-series dataset, where the time-series dataset comprises a set of data points having a relationship between (i) a set of timestamps and (ii) a value associated with a variable. Based on the time-series dataset, the system may generate a periodogram to determine power frequencies of a set of frequencies of the time-series dataset, where the periodogram is a frequency domain representation of the time-series dataset. The system may determine an asymptotic p-value based on the periodogram, where the asymptotic p-value of the periodogram indicates a probability value that a seasonal cycle is part of the time-series dataset. In response to a comparison between the asymptotic p-value and a threshold p-value indicating that the asymptotic p-value satisfies the threshold p-value, the system may determine a seasonality cycle of the time-series dataset. The system may then generate, for display on a user interface, a recommendation for a machine learning model based on (i) the seasonality cycle of the time-series dataset and (ii) the power frequencies of the set of frequencies of the time-series dataset.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative user interface for pre-selecting a machine learning model based on determined dataset characteristics, in accordance with one or more embodiments.

FIG. 2 shows an illustrative diagram for selecting a machine learning model from a set of machine learning models based on determined dataset characteristics, in accordance with one or more embodiments.

FIG. 3 shows illustrative components for a system used for pre-selecting a machine learning model based on determined dataset characteristics, in accordance with one or more embodiments.

FIG. 4 shows a flowchart of the steps involved in pre-selecting a machine learning model based on determined dataset characteristics, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

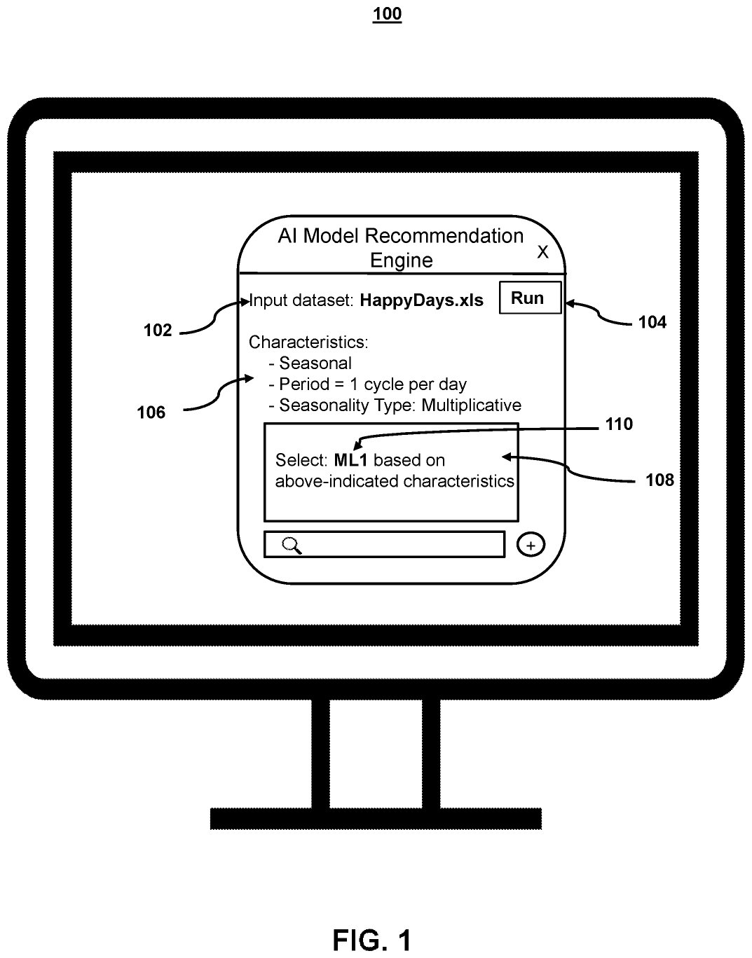

FIG. 1 shows an illustrative user interface for pre-selecting a machine learning model based on determined dataset characteristics, in accordance with one or more embodiments. For example, user interface 100 may include an indication of dataset 102, a button 104, a set of dataset characteristics 106, a recommendation 108, and a machine learning model 110. User interface 100 may provide a user a recommendation 108 indicating a machine learning model 110 that is pre-selected and/or configured to process a dataset 102 based on a set of dataset characteristics 106.

Since the advent of machine learning and artificial intelligence, multiple different types of machine learning models have been developed to solve problems, predict patterns, or otherwise process data. As such models have become more specialized to solve a given problem, such as in anomaly detection or forecasting events, the models require more and more specialized data. For example, in the context of machine learning models developed for anomaly detection, forecasting, and the like, time-series data is especially useful for anomaly detection and forecasting. However, for machine learning models to process time-series data, the machine learning models may require parameters prior to simply providing time-series data as input. Such parameters may include characteristics of the time-series data itself, such as whether seasonality exists (e.g., whether the time-series data exhibits a cyclic trend), what the period of seasonality is (e.g., how often the cyclic trend occurs), what type of seasonality is inherent in the time-series data (e.g., multiplicative, additive, etc.), or other characteristics of the data.

Determining such characteristics of the data (e.g., time-series data), however, is an arduous process that is error prone (e.g., as it relies on the mere opinion of computer scientists, data scientists, and the like), and is currently inadequate when dealing with (i) large datasets and (ii) high-dimensional datasets (e.g., datasets having greater than 20 dimensions). These technical deficiencies are caused by inadequate methods (e.g., Bartlett's periodogram, Fisher's test, etc.) that are computationally expensive, unable to handle large datasets without a loss of information, and inaccurate in the results they produce. The methods and systems disclosed herein overcome these technical deficiencies by (i) providing an improved user interface to enable users to determine dataset characteristics and (ii) efficiently determining such dataset characteristics that are able to handle large datasets, thereby improving the user experience while reducing utilization of computational resources (e.g., computer memory and processing resources).

As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, a “recommendation” may comprise a suggestion or proposal. For example, a recommendation for a machine learning model may include a set of available machine learning models, a selection of a given machine learning model, or other recommendation. For instance, the recommendation may be based on a set of dataset characteristics.

As referred to herein, “dataset characteristics” may comprise one or more attributes about the dataset itself. For example, dataset characteristics may include a format of the data (e.g., tabular, list, graphical, image data, textual data, etc.), a size of the data (e.g., number of dimensions of the data, a number of variables inherent in the data, a file size of the data, etc.), a trend in the data (e.g., a linear trend, a hyperbolic trend, a cyclic trend, a constant trend, etc.), a seasonality cycle (e.g., whether a dataset exhibits seasonality, whether a dataset includes a seasonal cycle, etc.) a seasonality trend in the data (e.g., how often a pattern is repeated with respect to time, a period of the seasonality cycle), a frequency of a trend (e.g., a frequency of a seasonality), a type of seasonality (e.g., multiplicative, additive, etc.), or other attributes of the dataset.

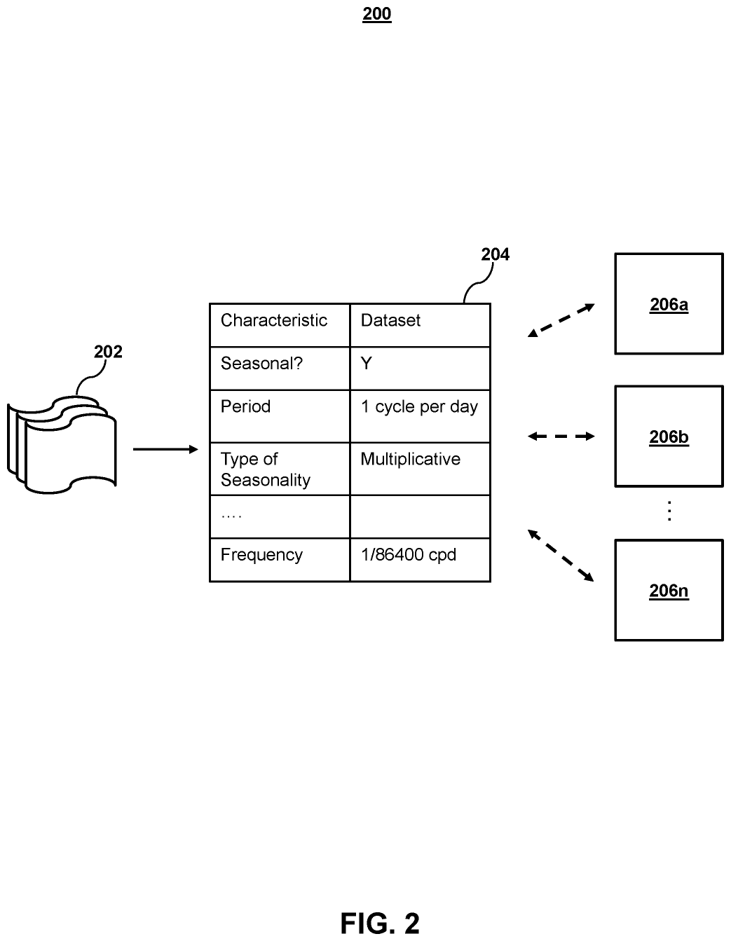

FIG. 2 shows an illustrative diagram for selecting a machine learning model from a set of machine learning models based on determined dataset characteristics, in accordance with one or more embodiments. For example, diagram 200 includes a dataset 202, a set of dataset characteristics 204, and machine learning models 206a-206n (or as collectively referred to as machine learning model 206). Dataset 202 may be any dataset. For example, dataset 202 may be a time-series dataset to which a set of dataset characteristics 204 are to be determined to base a recommendation of which machine learning model(s) 206 should be used to process dataset 202. As discussed above, in some cases, determining dataset characteristics of a given dataset may be necessary prior to providing the given dataset to a machine learning model. That is, some machine learning models simply cannot execute or process data without prior knowledge regarding the dataset (e.g., dataset characteristics). Moreover, when multiple machine learning models are available to process the given dataset based on the dataset's characteristics, one machine learning model may be better suited for processing the dataset than another machine learning model. Thus, to improve the user experience when selecting a machine learning model for processing a dataset, the system may determine dataset characteristics of a dataset, and based on such dataset characteristics, may provide a recommendation regarding a machine learning model configured to accurately process the dataset.

As described herein, “time-series data” or alternatively a “time-series dataset” may include a sequence of data points that occur in successive order over some period of time. In some embodiments, time-series data may be contrasted with cross-sectional data, which captures a point in time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time-series analysis. For example, a time-series analysis may be useful to see how a given asset, security, or economic variable changes over time. It can also be used to examine how the changes associated with the chosen data point compare to shifts in other variables over the same time period. For example, with regard to retail loss, the system may receive time-series data for the various sub-segments indicating daily values for theft, product returns, etc.

The time-series analysis may determine various trends such as a secular trend (which describes the movement along the term), a seasonal variation (which represents seasonal changes), cyclical fluctuations (which correspond to periodical but not seasonal variations), and irregular variations (which are other nonrandom sources of variations of series). The system may maintain correlations for this data during modeling. In particular, the system may maintain correlations through non-normalization as normalizing data inherently changes the underlying data, which may render correlations, if any, undetectable and/or lead to the detection of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of a non-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions, while providing an allowance for covariate adjustment. Since no distributional assumptions are made, these tests may be applied to data that has been processed under any normalization strategy or not processed under a normalization strategy at all.

As referred to herein, a “periodogram” may include an estimate of a spectral density of a signal or a dataset. For example, the periodogram may be a frequency domain representation of a dataset that compares amplitude vs. frequency characteristics of the dataset. In some embodiments, the periodogram may be a Welch periodogram, a Bartlett periodogram, or other periodogram. In some embodiments, the periodogram may compare the power of a dataset with the frequency of the dataset. In some embodiments, the periodogram may be used to determine power frequencies of a dataset.

As referred to herein, “power frequencies” may comprise the power spectral density (PSD) of a signal or dataset with respect to a given frequency of the signal/dataset. In some embodiments, the power frequencies may include a set of statistically significant frequencies of a set of frequencies of the dataset with respect to a power value of such frequencies. In some embodiments, the power frequencies may include a value (or a set of values) of the power at a given frequency of the set of frequencies of a dataset.

As referred to herein, an “asymptotic p-value” or “asymptotic p-values” may comprise a probability that a particular statistical measure of an assumed probability distribution will be greater than or equal to observed results. In some embodiments, the asymptotic p-values may comprise a mean or standard deviation of the assumed probability distribution being greater than or equal to observed results. In some embodiments, the asymptotic p-value may comprise a statistical measure of an assumed probability distribution being less than or equal to observed results. In some embodiments, the asymptotic p-value may comprise a p-value that is determined using an approximation to the true distribution.

As referred to herein, “seasonality” may comprise a characteristic of a time-series dataset that occurs with respect to time. For example, seasonality may be hourly, daily, weekly, monthly, yearly, or other occurrence with respect to time. In some embodiments, seasonality may comprise a characteristic of a time-series dataset in which the dataset experiences regular and predictable changes that reoccur with respect to time. In some embodiments, seasonality may be associated with a given period, frequency, or other quantitative metric. In some embodiments, seasonality may be associated with a given type. For example, a multiplicative seasonality type may refer to changes with respect to the widths or heights of seasonal periods over time. As another example, an additive seasonality type may refer to no changes with respect to the widths or heights of seasonal periods over time. In some embodiments, seasonality may be associated with a given trend. For example, a multiplicative seasonality may refer to a non-linear trend line of a time-series dataset. As another example, an additive seasonality may refer to a linear trend line of a time-series dataset.

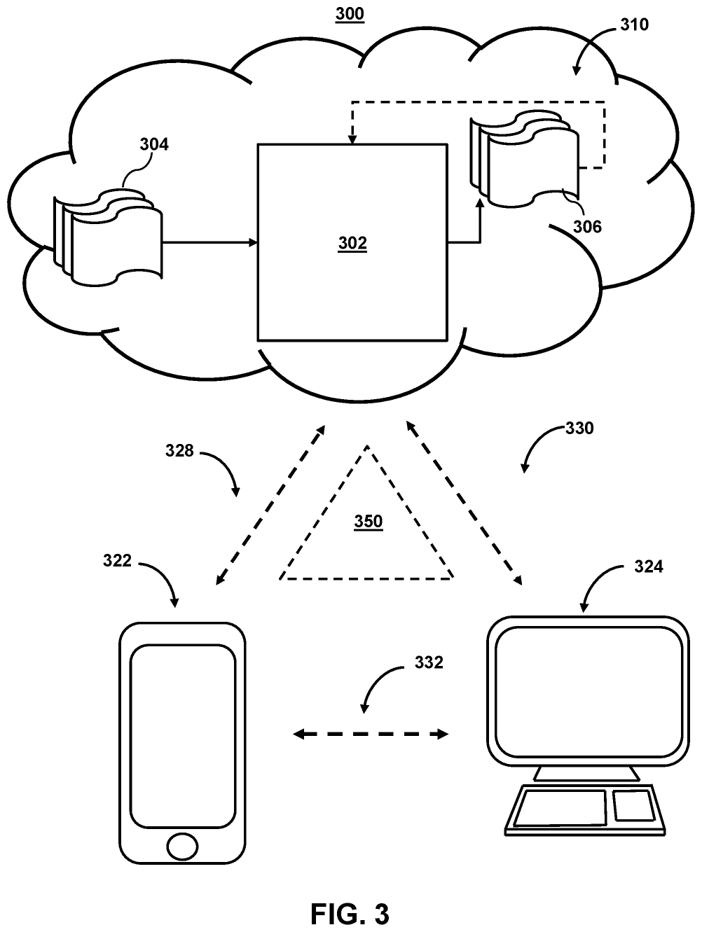

FIG. 3 shows illustrative components for a system used for pre-selecting a machine learning model based on determined dataset characteristics, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., user interfaces, predictions to known or unknown errors, interactive links to source code files, source code file-related information, error-related information, update information, or other information).

Additionally, as mobile device 322 and user terminal 324 are shown as a touchscreen smartphone and a computer, these displays also act as user input interfaces. It should be noted that in some embodiments, the devices may have neither user input interfaces nor displays, and they may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include one or more components of FIG. 2. In some embodiments, cloud components 310 may represent a remote computing network (e.g., remote from mobile device 322 or user terminal 324). For example, cloud components 310 may include a remote server (e.g., for performing one or more functionalities disclosed herein), a database (e.g., for storing datasets, machine learning models, graphical user interfaces, dataset characteristics, etc.), a machine learning model recommendation module, or other components.

Cloud components 310 may access one or more remote databases. For example, cloud components 310 may access various databases, such as training data databases, system data databases, machine learning model databases, or other databases. For instance, a training data database may be a database configured to store training data for one or more machine learning models, in accordance with one or more embodiments. Training data may include labeled training data associated with dataset characteristics, such as seasonality cycle, seasonality types, periods of seasonality cycles, frequencies of seasonality cycles, power frequencies, or other information. The training data may also include machine learning model identifiers (e.g., that identify a machine learning model by type or configuration), and historical recommendations of machine learning models with respect to dataset characteristics. In this way, the system may use such training data to train a machine learning model to provide a recommendation regarding a machine learning model with respect to dataset characteristics.

A system data database may be a database configured to store system information. For example, the system information may include messages, graphical components, images, videos, multimedia, historical recommendations of machine learning models, periodogram generation methods, asymptotic p-values, threshold p-values, threshold asymptotic p-values, power frequencies, seasonality information (e.g., seasonality cycles, seasonality types, periods, frequencies, etc.), autocorrelation functions, trend models (e.g., constant trend models, linear trend models, hyperbolic trend models, etc.), spectral decomposition techniques, or other system information. A machine learning database may be a database that is configured to store machine learning models (e.g., trained or untrained machine learning models). For example, the machine learning models may be neural networks, convolutional neural networks, recurrent neural networks, generative adversarial networks, support vector machines, Bayesian models, or other machine learning or artificial intelligence models.

Cloud components 310 may include model 302, which may be a machine learning model, an artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. For example, the inputs may include update information, messages related to an error, identifiers of an automation pipeline feature, a context associated with the automation pipeline feature, or other information. The outputs may include resolutions to errors, predicted resolutions to errors, an indication of a resolution to an error, or other error-related information. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., recommendations of machine learning models to process a dataset, a set of recommendations, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving as compared to traditional computer programs. During training, an output layer of model 302 may correspond to a classification of model 302, and an input known to correspond to that classification may be input into an input layer of model 302 during training. During testing, an input without a known classification may be input into the input layer and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., recommendations of machine learning models to process a dataset, a set of recommendations, etc.).

In some embodiments, the model (e.g., model 302) may automatically perform actions based on outputs 306. In some embodiments, the model (e.g., model 302) may not perform any actions. The output of the model (e.g., model 302) may be used to retrieve a model in response to recommending a given machine learning model for use in processing a given dataset, to enable a user selection of a model in response to recommending a given machine learning model for use in processing a given dataset, to use a recommended machine learning model to process a given dataset, or other functionalities, in accordance with one or more embodiments.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of API layer 350 may provide integration between front-end and back-end layers. In such cases, API layer 350 may use RESTful APIs (exposition to front-end layer or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDOS protection, and API layer 350 may use RESTful APIs as standard for external integration.

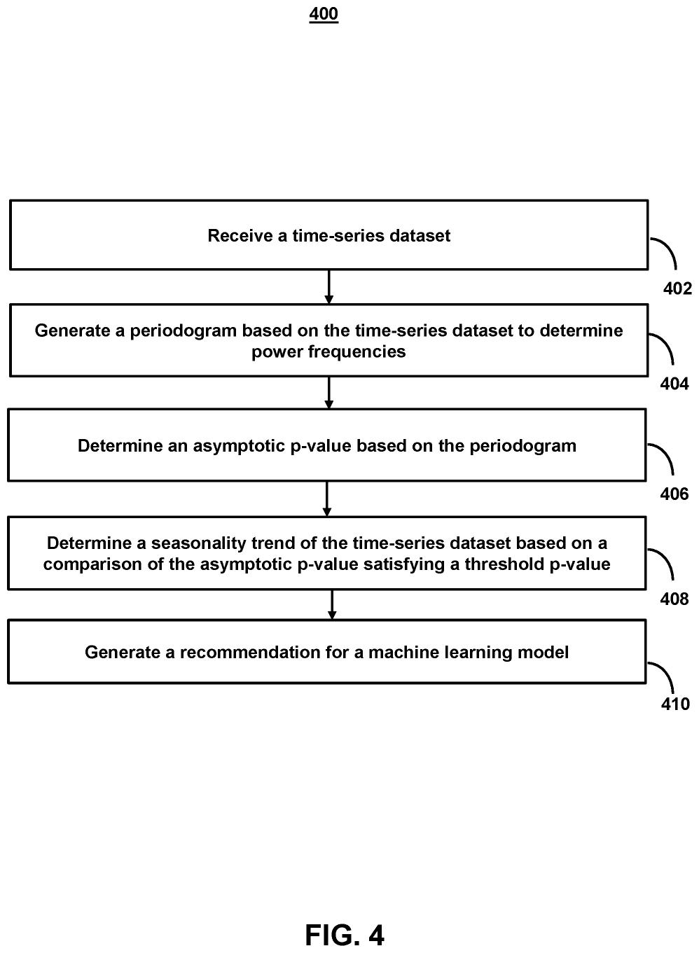

FIG. 4 shows a flowchart of the steps involved in reducing utilization of computational resources involved in pre-selecting a machine learning model based on determined dataset characteristics, in accordance with one or more embodiments. For example, the system may use process 400 (e.g., as implemented on one or more system components described above) for pre-selecting a machine learning model based on determined dataset characteristics, in accordance with one or more embodiments.

At step 402, process 400 (e.g., using one or more components described above) may receive a time-series dataset. For example, the system may receive a time-series dataset, where the time-series dataset comprises a set of data points having a relationship between (i) a set of timestamps and (ii) a value associated with a variable. For example, a timestamp of the set of timestamps may indicate a time/date in epoch time, Unix time, or other time metric. The value may be any value (e.g., an integer, decimal, ratio, percentage, etc.) that is associated with a given variable. For example, where the variable is Sunny Days, the value may be a 1 or 0 indicating whether a given day was sunny or not sunny. As another example, where the variable is trades (e.g., in the context of the stock market), the value may be a number indicating how many trades were performed. In this way, the system may receive a dataset to determine characteristics of the dataset to enable the system to provide an accurate recommendation of a machine learning model configured to process the dataset in an easy-to-use user interface, thereby improving the user experience.

Referring to FIG. 1, in some embodiments, the system may generate a user interface 100. For instance, user interface 100 may enable a user to provide a dataset to the system. For example, the user may provide dataset 102 (e.g., a time-series dataset) into an input field of the user interface. In some embodiments, the user may select button 104 (e.g., “Run” button) to determine a set of dataset characteristics 106 of the provided dataset.

Referring back to FIG. 4, at step 404, process 400 (e.g., using one or more components described above) may generate a periodogram based on the time-series dataset to determine power frequencies. For example, the system may generate the periodogram based on the time-series dataset to determine power frequencies of a set of frequencies of the time-series dataset, where the periodogram is a frequency domain representation of the time-series dataset. For example, the power frequencies may be the dominant or significant frequencies that contribute to a variation, oscillation, or seasonality cycle within a time-series dataset. In some embodiments, the system may generate the periodogram for display on a user interface to enable the user to view the generated periodogram.

Generating a periodogram is advantageous when determining one or more dataset characteristics of a given dataset. For example, in the context of time-series datasets, periodograms provide valuable information regarding the frequency content of a time series (e.g., a time-series dataset), identification of periodic patterns (e.g., periodic patterns, cycles, and dominant or power frequencies of periodic components in the dataset), seasonality detection, power spectral density of the time series (e.g., how power is distributed across different frequencies of the time series), noisy components, spectral estimation characteristics, or other information. By leveraging such information, the system may extract these dataset characteristics for use in recommending a machine learning model for processing the time-series dataset.

However, not all periodograms are created equal. For example, varying methods for generating periodograms exist. Some methodologies are inadequate and cannot produce or otherwise generate periodograms using large datasets. For example, a common methodology to generate a periodogram is using Bartlett's method. However, Bartlett's method is limited to time-series datasets with a small dimensional count. For instance, Bartlett's method may be configured for time-series datasets having 1, 2, . . . 20 dimensions to generate a periodogram. Although Bartlett's method may produce a periodogram for small dimensional datasets, this solution is not scalable to larger dimensional time-series datasets (e.g., 20 or more dimensions). As such, the methods and systems described herein leverage an alternative approach that is not limited to small dimensions and is scalable to any dataset size (e.g., dimensional size), thereby improving dataset characteristic extraction and improving the user experience (e.g., as users may simply provide any dataset to the system to extract dataset characteristics).

The system may determine the power frequencies of the set of frequencies of the time-series dataset. For example, upon generating a periodogram, the system may rank each frequency of the set of frequencies based on power values associated with the frequencies. For instance, the system may extract each frequency of the set of frequencies of the time-series dataset, and may order the extracted frequencies based on the respective extracted frequencies power values. For example, the power values may be of a metric of magnitude, amplitude, or the like. For instance, a power value may be measured in watts. The system may order the extracted frequencies in an ascending or descending order to rank each frequency of the set of frequencies. The system may then generate, for display in a user interface, a visual representation of the ordered set of extracted frequencies. By doing so, a user may be presented with the visual representation and may select (e.g., determine) the set of power frequencies associated with the time-series dataset. In some embodiments, the system may select a set of power frequencies of the set of frequencies by comparing each frequency's (e.g., of the set of frequencies) power values to a threshold value. The threshold value may be a predetermined or a user-selected value. In response to a frequency's power value meeting or exceeding the threshold power value, the system may select the frequency as a power frequency (e.g., or to be part of the set of power frequencies). In this way, the system may leverage such power frequencies to determine a period of a seasonal cycle associated with the time-series dataset, thereby enhancing machine learning model recommendations based on dataset characteristics.

In some embodiments, the system may generate the periodogram based on a linear trend model. For example, the system may receive a user selection of a linear trend model. In response to receiving the user selection of the linear trend model, the system may generate the periodogram using the linear trend model. For instance, the system may retrieve a set of linear trend models to generate the periodogram from a database (e.g., system data database). As another example, the set of linear trend models may be part of a computer programming language package (e.g., a Python package, SciPy, etc.). In some embodiments, the system may generate for display the set of linear trend models such that the user may select a linear trend model from the set of linear trend models. In response to receiving a user selection of a linear trend model from the set of linear trend models, the system may generate the periodogram using the linear trend model. By generating the periodogram based on a linear trend model, the system may detrend the time-series dataset. For example, detrending the time-series dataset enables the isolation of seasonal patterns, provides more accurate forecasting, quantifies seasonal effects (e.g., strength and duration of seasonal patterns), de-emphasizes irregular fluctuations within the dataset, enhances anomaly detection, and provides for the most accurate seasonal periods to be determined from the time-series dataset. Additionally, the benefit of using a linear trend model is the fact that linear trend models capture long-term trends, are more robust, and provide a better basis for forecasting trends linear trend models capture both historical and seasonal cycles. In this way, the system may determine more accurate dataset characteristics by detrending the time-series dataset.

In some embodiments, the system may generate the periodogram based on a constant trend model. For example, similar to the above, the system may generate the periodogram based on a constant trend model in response to receiving a user selection of a constant trend model. For example, the system may receive a user selection (e.g., from a set of constant trend models) of a constant trend model. In some embodiments, the system may retrieve the set of constant trend models from a database (e.g., system data database) or from a computer programming language package (e.g., a Python package, SciPy, etc.). In some embodiments, the system may generate for display the set of constant trend models such that the user may select a constant trend model from the set of constant trend models. In response to receiving a user selection of a constant trend model from the set of constant trend models, the system may generate the periodogram using the constant trend model. The benefit of using a constant trend model is that constant trend models are simple, improve noise reduction (e.g., the periodogram becomes focused on variations around a constant mean), and emphasize seasonal patterns, thereby enabling more accurate generation of dataset characteristics.

Additionally or alternatively, the system may generate the periodogram using Welch's method. For example, the system may retrieve from a database (e.g., system data database) a set of periodogram generation methods (e.g., Welch's, Bartlett's, etc.). The system may generate, for display on a user interface, the set of periodogram generation methods to enable the user to select a periodogram generation method. In response to receiving a user selection of a Welch periodogram generation method, the system may generate the periodogram based on the Welch periodogram generation method. Additionally or alternatively, the system may receive a user selection of Welch periodogram parameters associated with the time-series dataset. For instance, the Welch periodogram parameters may comprise an indication of a window function (e.g., a function that segments the data into overlapping or non-overlapping windows, such as Hanning, Blackman, Bartlett, or other window functions), a desired window length (e.g., segment length), an indication as to whether overlapping or non-overlapping windows are to be used (e.g., “Yes,” “No,” 1, 0, etc.), a number of segments (or windows), a sampling rate, or other Welch periodogram parameters. In response to receiving the user selection of Welch periodogram parameters, the system may generate a Welch periodogram using the Welch periodogram parameters, where the generated periodogram is a Welch periodogram based on the time-series dataset.

As discussed above, not all periodograms are created equal. While existing systems may base periodograms on Bartlett's method, Bartlett's method is inadequate for large time-series datasets having large dimensions (e.g., dimensions greater than 20). As such, the benefit of using a Welch periodogram is realized as such periodogram is optimized for greater dimensional time-series datasets. Furthermore, Welch's periodogram offers enhanced spectral estimation, which provides more accurate seasonality cycle discovery and periodicity values (e.g., dataset characteristics). For instance, as Bartlett's periodogram suffers from window-length sensitivity when computing the periodogram (e.g., too small of a window length results in poor frequency resolution and too great of a window length may smooth over important spectral features), information is lost when generating Bartlett's periodogram, thereby leading to inaccurate results. Welch's periodogram, however, is not window-length sensitive and maintains inherent data features within time-series data by using a non-segmented window approach. For example, while Bartlett's method relies on a segmented, non-overlapping, window-driven approach when generating the periodogram based on the time-series dataset, the system may experience lag as such segmented approach is computationally expensive. On the other hand, Welch's periodogram features a segmented, overlapping, window-driven approach where each segment is individually processed in parallel, thereby leading to smaller data segments as opposed to considering each segment with respect to all segments within the dataset, which improves computational efficiency.

In some embodiments, the system may update a time-series dataset by removing power frequencies. For example, the system may determine, for each power frequency of the set of frequencies, whether a power value associated with a respective power frequency is greater than half of a length associated with the time-series dataset. The power value may be any value with respect to a power metric. For example, a power value may be 0.000001 watts, 0.1 watts, 1 watt, 2 watts, 10 watts, 100 watts, 1000 watts, and so on. The length associated with the time-series dataset may be a length of time associated with the time-series dataset (e.g., a range of time from a first data point's timestamp to a second data point's timestamp with respect to the time-series dataset), or other length. The system may determine, for each power frequency (e.g., based on a periodogram), whether a power frequency's power value is greater than half of the length associated with the time-series dataset. For instance, where a power frequency is 7 watts, and the length of the dataset is 10 days, then the system may update the time-series dataset. For example, the system may update the time-series dataset by removing each power frequency that has a power value that is greater than half of the length associated with the time-series dataset. Continuing with the example above, the system may update the time-series dataset by removing the data point that has a power frequency of 7 watts. In this way, the system may further detrend the time-series dataset to enable more accurate and robust dataset characteristics to be determined.

At step 406, process 400 (e.g., using one or more components described above) may determine an asymptotic p-value based on the periodogram. For example, the system may determine an asymptotic p-value based on the periodogram, where the asymptotic p-value of the periodogram indicates a probability value that a seasonal cycle is part of the time-series dataset. In some embodiments, the asymptotic p-value may be based on the power frequencies. The system may determine the asymptotic p-value using one or more unit root tests (e.g., Augmented Dickey-Fuller test), tests for serial correlation (e.g., Ljunh-Box test), or other statistical test methodologies. For instance, the asymptotic p-value may be a p-value that is an approximation for statistical distributions (e.g., of a periodogram) where the sample size is large (e.g., due to a large dataset, a large dimensional time-series dataset, etc.). Similar to exact p-values in null hypothesis analytics for providing a quantifiable value in the evidence against a null hypothesis in a hypothesis test, the p-value represents the probability of observing a test statistic as extreme as, or more extreme than, what was actually observed, assuming that the null hypothesis is true. That is, a p-value indicates the likelihood of obtaining observed results if the null hypothesis was correct.

In some embodiments, the system may determine an asymptotic p-value based on the power frequencies. For example, the system may receive a user selection of a spectral decomposition technique using orthonormal functions. For instance, existing spectral decomposition techniques for determining p-values (e.g., asymptotic p-values) are limited due to the lack of scalability (e.g., due to large dimensional size of time-series data). Such techniques rely on applying those techniques to non-Welch periodograms which, if applied to large dimensional time-series datasets, provide inaccurate asymptotic p-values, thereby leading to skewed seasonality cycle determination. To overcome these technical deficiencies, the system may use a spectral decomposition technique using orthonormal functions as applied to the Welch periodogram to determine the asymptotic p-value. One such example may be the spectral decomposition technique using orthonormal functions derived from the Aittokallio, Gyllenberg, Nevalaien model (2002). For example, a spectral decomposition technique using orthonormal functions may break down a signal (e.g., a time-series dataset) into its constituent frequency components using a set of orthogonal basis functions (e.g., Fourier or wavelet analysis). Such decomposition provides enhanced frequency analysis, amplitude and phase information, noise separation, and periodic pattern identification. Leveraging the determined power frequencies, when applying the spectral decomposition technique using orthonormal functions, the system may generate a more accurate asymptotic p-value, as the Welch periodogram and the spectral decomposition technique (e.g., using orthonormal functions) do not lose valuable seasonality information and reduce time-series data noise-thereby enabling accurate determination of seasonal periodicity (e.g., dataset characteristics).

At step 408, process 400 (e.g., using one or more components described above) may determine a seasonality cycle of the time-series dataset based on a comparison of the asymptotic p-value satisfying a threshold p-value. For example, in response to a comparison between the asymptotic p-value to a threshold p-value indicating that the asymptotic p-value satisfies the threshold p-value, the system may determine a seasonality cycle of the time-series dataset.

For example, in the context of determining whether seasonality exists within a time-series dataset, the null hypothesis indicates that there is no seasonality within the time-series dataset. Upon generating a periodogram of the time-series dataset, a p-value may be determined, which may indicate a value representing the probability that seasonality exists. To determine whether seasonality exists, the system may compare the asymptotic p-value to a threshold p-value. As discussed above, the asymptotic p-value may be an approximate p-value used for large dataset sample sizes. The threshold p-value may be a predetermined threshold p-value (e.g., 0.05, 0.01, 0.02, 5%, 1%, 2%, etc.) or may be a user-selected threshold p-value. In this way, the user may have more control as to whether seasonality exists within the time-series dataset.

The comparison may indicate whether the asymptotic p-value satisfies the threshold p-value. For example, the asymptotic p-value may satisfy the threshold p-value when the asymptotic p-value fails to meet or exceed the threshold p-value (e.g., indicating to reject the null hypothesis). As such, the system may determine a seasonality cycle of the time-series dataset (e.g., that seasonality exists within the time-series dataset). The asymptotic p-value may fail to satisfy the threshold p-value when the asymptotic p-value meets or exceeds the threshold p-value (e.g., indicating to reject an alternative hypothesis). As such, the system may determine a seasonality cycle of the time-series dataset (e.g., that seasonality does not exist within the time-series dataset).

At step 410, process 400 (e.g., using one or more components described above) may generate a recommendation for a machine learning model. For example, the system may generate, for display on a user interface, a recommendation for a machine learning model based on (i) the seasonality cycle of the time-series dataset and (ii) the power frequencies of the set of frequencies of the time-series dataset. In some embodiments, the seasonality cycle may indicate whether seasonality exists within the time-series dataset. For example, where the time-series dataset includes a seasonal cycle, the system may recommend a machine learning model to process the time-series dataset based on the time-series dataset having a seasonal cycle. Additionally or alternatively, the system may further recommend a machine learning model for processing the time-series dataset based on the power frequencies of the set of frequencies of the time-series dataset. For example, the power frequencies may be used to, indicate a period of the seasonality exhibited in the time-series dataset. As such, the system may generate a recommendation for a given machine learning model to process the time-series dataset using (i) the seasonality cycle and (ii) the power frequencies. In this way, the system may accurately recommend machine learning models to process large time-series datasets based on the dataset characteristics of the time-series datasets, thereby improving the user experience while enhancing machine learning model-derived predictions (e.g., as the recommended machine learning model is configured to particular types of datasets).

As an example, referring to FIG. 1, the system may generate a recommendation 108 for a machine learning model 110. The recommendation 108 may be displayed within a user interface 100 for the user to view or select the machine learning model 110 to process the time-series dataset 102. In some embodiments, a visual indication indicating the machine learning model 110 may be interactive. For example, upon a user selection of the machine learning model 110, the system may populate the machine learning model in a new user interface with the determined dataset characteristics (e.g., seasonal, period, seasonality type, etc.) auto populated into the configuration of the machine learning model, thereby further enhancing the user experience and reducing the utilization of computational resources (e.g., as otherwise caused by the system providing requests for such dataset characteristic information).

In some embodiments, the recommendation for the machine learning model may be generated based on a trained machine learning model. For example, machine learning model 302 (FIG. 3) may be configured to generate recommendations for other machine learning models to process the dataset based on the dataset characteristics. The system may provide labeled data as input to the trained machine learning model, such as the seasonality cycle, a period associated with the time-series dataset, power frequencies associated with the time-series dataset, a seasonality type, other dataset characteristics (e.g., determined dataset characteristics), or other information, to generate an output indicating a recommended machine learning model to process the time-series data. Additionally or alternatively, machine learning model identifiers may be provided as input to the trained machine learning model to generate the recommendation for the machine learning model to process the time-series dataset. In this way, the system may produce more accurate and robust recommendations for machine learning models.

In some embodiments, generating the recommendation for the machine learning model may be based on a period. For example, in response to determining the seasonality cycle of the time-series dataset, the system may determine a period associated with the seasonality cycle based on the power frequencies of the time-series dataset. For instance, the system may determine a first timestamp of the time-series dataset that corresponds to a first power value of a first frequency of the set of power frequencies of the time-series dataset. The system may also determine a second timestamp of the time-series dataset that corresponds to a second power value of a second frequency of the set of power frequencies of the time-series dataset. In some embodiments, the system may determine the first and second timestamps based on the generated periodogram using the set of power frequencies. The system may then determine that the first power value of the first frequency corresponds to (e.g., is equal to, or within a threshold value of) the second power value of the second frequency. Upon determining that the first power value of the first frequency and the second power value of the second frequency correspond to each other, the system may determine a time difference between the first and second timestamps to determine the period associated with the seasonality cycle. When the period associated with the seasonality cycle is determined, the system may generate the recommendation for the machine learning model further based on the period associated with the seasonality cycle of the time-series dataset. For example, the system may select a machine learning model of a set of machine learning models that is configured to accept a period parameter of a time-series dataset. Additionally or alternatively, the system may select a machine learning model of a set of machine learning models that is configured with the determined period (e.g., a machine learning model that is preconfigured to accept a period that matches the determined period). In this way, the system may generate accurate recommendations as to which machine learning model may be used to process the time-series data.

In some embodiments, the period associated with the seasonality cycle may be determined based on a set of periods. For example, the system may identify, based on the power frequencies of the set of frequencies of the time-series dataset, a subset of power frequencies of the power frequencies. Each power frequency of the subset of power frequencies may be associated with a power value that is greater than a threshold power value. For example, the threshold power value may be a predetermined threshold power value. The system may then determine a set of periods associated with the time-series dataset, where each period of the set of periods is associated with (i) a respective power frequency of the subset of power frequencies and (ii) a power value associated with the respective power frequency of the subset of power frequencies. For example, the set of periods may be an array of the periods associated with the time-series dataset. The system may then determine the period associated with the seasonality cycle by selecting a first period from the set of periods that is associated with a first power value that is greater than that of the other power values associated with the set of periods. For example, the system may select the period to which corresponds (e.g., matches) the greatest power value of all the power values associated with the set of periods. In this way, the system may select the most statistically significant power value, thereby providing the most accurate period determination.

In some embodiments, the system may determine the period associated with the seasonality cycle based on an autocorrelation function. For example, the system may apply an autocorrelation function to the time-series dataset (e.g., or the periodogram) to determine the period associated with the seasonality cycle based on the power frequencies. That is, as the power frequencies provide the statistically significant power values of the time-series dataset, the system may use an autocorrelation function (e.g., retrieved from a system data database, or part of a computer programming language package (SciPy)) to automatically determine the period associated with the seasonality cycle of the time-series dataset. For instance, the autocorrelation function may provide a set of periods that are exhibited by the time-series dataset. In such case, the system may select a period from a set of determined periods resulting from the application of the autocorrelation function that is associated with a first autocorrelation value that is greater than second autocorrelation values associated with other periods of the set of periods resulting from the application of the autocorrelation function. For example, where the auto correlation function provides a set of periods, the system may select the largest autocorrelation value among the other autocorrelation values that correspond to each period of the set of periods. When the system selects the largest autocorrelation value (e.g., indicating the highest degree of linear dependence/correlation between the time-series dataset and lagged versions of the time-series dataset), the system may identify the period that corresponds to (e.g., is associated with) the largest autocorrelation value. The system may then determine the period associated with the seasonality cycle of the time-series dataset using the identified period that corresponds to the largest autocorrelation value. In this way, the system may identify the most accurate period associated with the seasonality cycle of the time-series dataset.

In some embodiments, generating the recommendation for the machine learning model may be based on a machine learning model that corresponds to a period associated with the seasonality cycle of the time-series dataset. For example, the system may determine a set of machine learning models configured to receive the time-series dataset using the seasonality cycle of the time-series dataset. A plurality of machine learning models may be stored in a database (e.g., a machine learning model database) that may be of a variety of types (e.g., neural networks, recurrent neural networks, support vector machines, etc.). The system may use the seasonality cycle of the time-series dataset (e.g., whether seasonality exists in the time-series dataset) to determine a set of machine learning models that are configured to receive the time-series dataset. For example, the set of machine learning models may be machine learning models that are able to process a time-series dataset that is associated with a seasonal cycle (e.g., recurrent neural networks (RNNs), long short-term memory (LSTM) models, multilayer perceptron (MLP) models, etc.). The system may then select, from the set of machine learning models, a first machine learning model, where the first machine learning model corresponds to a period associated with the seasonality cycle of the time-series dataset based on the power frequencies of the set of frequencies of the time-series dataset. For instance, as described above, the system may determine a period associated with the seasonality cycle of the time-series dataset. The system may use the determined period to determine whether a first machine learning model of the set of machine learning models corresponds to the determined period. For example, the first machine learning model may correspond to the determined period where the first machine learning model is pre-configured (e.g., has a period parameter) to match the determined period associated with the seasonality cycle of the time-series dataset. As another example, the first machine learning model may correspond to the determined period where the first machine learning model is able to accept a period parameter of the determined period associated with the time-series dataset. The system may then generate the recommendation for the machine learning model using the selected first machine learning model. For example, the system may generate, for display on a user interface, a visual indication of the selected first machine learning model to process the time-series dataset. In this way, the system may generate accurate recommendations for machine learning models to process the time-series dataset.

Additionally or alternatively, the system may further generate the recommendation for the machine learning model further based on a type of seasonality. For example, the system may determine a type of seasonality of the time-series dataset based on an optimal residual analysis technique of the time-series dataset. The optimal residual analysis technique may be a normality of residuals technique, a homoscedasticity technique, an independence of residuals technique, an outlier detection technique, a residual distribution analysis technique, or a randomness check. The optimal residual analysis technique may provide an indication as to the type of seasonality of the time-series dataset, such as whether the seasonality is of a multiplicative or additive type of seasonality. In addition to the period associated with the seasonality of the time-series dataset, the system may select, from the set of machine learning models, a second machine learning model, where the second machine learning model corresponds to (i) the period associated with the seasonality cycle of the time-series dataset and (ii) the type of seasonality of the time-series dataset. For example, the second machine learning model may correspond to the type of seasonality of the time-series dataset where the second machine learning model is pre-configured (e.g., has a seasonality type parameter) to match the type of seasonality of the time-series dataset. As another example, the second machine learning model may correspond to the type of seasonality of the time-series dataset where the second machine learning model is able to accept a seasonality type parameter of the determined type of seasonality of the time-series dataset. The system may then generate the recommendation for the machine learning model using the selected second machine learning model. For example, the system may generate, for display on a user interface, a visual indication of the selected second machine learning model to process the time-series dataset. In this way, the system may generate accurate recommendations for machine learning models to process the time-series dataset.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims, which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving a time-series dataset, the time-series dataset comprising a set of data points having a relationship between (i) a set of timestamps and (ii) a value associated with a variable; generating a periodogram based on the time-series dataset to determine power frequencies of a set of frequencies of the time-series dataset, wherein the periodogram is a frequency domain representation of the time-series dataset; determining an asymptotic p-value based on the periodogram, wherein the asymptotic p-value of the periodogram indicates a probability value that a seasonal cycle is part of the time-series dataset; in response to a comparison between the asymptotic p-value and a threshold p-value indicates that the asymptotic p-value exceeds the threshold p-value, determining a seasonality cycle of the time-series dataset, wherein the comparison indicates that the asymptotic p-value fails to exceed the threshold p-value; and generating, for display, on a user interface, a recommendation for a machine learning model based on (i) the seasonality cycle of the time-series dataset and (ii) the power frequencies of the set of frequencies of the time-series dataset.
2. The method of the preceding embodiment, wherein generating the recommendation for the machine learning model further comprises: in response to determining the seasonality cycle of the time-series dataset, determining a period associated with the seasonality cycle based on the power frequencies of the time-series dataset, wherein the seasonality cycle of the time-series dataset is determined; and generating the recommendation for the machine learning model further based on the period associated with the seasonality cycle of the time-series dataset.
3. The method of any one of the preceding embodiments, further comprising: identifying, based on the power frequencies of the set of frequencies of the time-series dataset, a subset of power frequencies of the power frequencies, wherein each power frequency of the subset of power frequencies is associated with a power value that is greater than a threshold power value; determining a set of periods associated with the time-series dataset, wherein each period of the set of periods is associated with (i) a respective power frequency of the subset of power frequencies and (ii) a power value associated with the respective power frequency of the subset of power frequencies; and determining the period associated with the seasonality cycle by selecting a first period from the set of periods that is associated with a first power value that is greater than that of other power values associated with the set of periods.
4. The method of any one of the preceding embodiments, wherein determining the period associated with the seasonality cycle based on the power frequencies of the time-series dataset comprises applying an autocorrelation function to the time-series dataset.
5. The method of any one of the preceding embodiments, wherein determining the period associated with the seasonality cycle based on the power frequencies of the time-series dataset further comprises selecting a period from a set of periods resulting from the application of the autocorrelation function that is associated with a first autocorrelation value that is greater than second autocorrelation values associated with other periods from the set of periods resulting from the application of the autocorrelation function.
6. The method of any one of the preceding embodiments, wherein generating the periodogram further comprises: receiving a user selection of a constant trend model; and generating the periodogram using the constant trend model.
7. The method of any one of the preceding embodiments, wherein generating the periodogram further comprises: receiving a user selection of a linear trend model; and generating the periodogram using the linear trend model.
8. The method of any one of the preceding embodiments, further comprising: determining, for each power frequency of the set of frequencies, whether a power value associated with a respective power frequency is greater than half of a length associated with the time-series dataset; and updating the time-series dataset by removing each power frequency that has a power value that is greater than half of the length associated with the time-series dataset.
9. The method of any one of the preceding embodiments, wherein determining the asymptotic p-value based on the power frequencies further comprises: receiving a user selection of a spectral decomposition technique using orthonormal functions; and applying the spectral decomposition technique using orthonormal functions to the generated periodogram.
10. The method of any one of the preceding embodiments, wherein generating the periodogram further comprises: receiving a user selection of Welch periodogram parameters associated with the time-series dataset; and generating the periodogram using the Welch periodogram parameters, wherein the generated periodogram is a Welch periodogram based on the time-series dataset.
11. The method of any one of the preceding embodiments, wherein the threshold p-value is a user-selected threshold value.
12. The method of any one of the preceding embodiments, wherein generating the recommendation for the machine learning model further comprises: determining a set of machine learning models configured to receive the time-series dataset using the seasonality cycle of the time-series dataset; selecting, from the set of machine learning models, a first machine learning model, wherein the first machine learning model corresponds to a period associated with the seasonality cycle of the time-series dataset based on the power frequencies of the set of frequencies of the time-series dataset; and generating the recommendation for the machine learning model using the selected first machine learning model.
13. The method of any one of the preceding embodiments, wherein generating the recommendation for the machine learning model further comprises: determining a type of seasonality of the time-series dataset based on an optimal residual analysis technique of the time-series dataset, wherein the type of seasonality is a multiplicative type or an additive type; determining a set of machine learning models configured to receive the time-series dataset using (i) the seasonality cycle of the time-series dataset and (ii) the type of seasonality of the time-series dataset; selecting, from the set of machine learning models, a first machine learning model, wherein the first machine learning model corresponds to (i) a period associated with the seasonality cycle of the time-series dataset based on the power frequencies of the set of frequencies of the time-series dataset and (ii) the type of seasonality of the time-series dataset; and generating the recommendation for the machine learning model using the selected first machine learning model.
14. A tangible, non-transitory machine-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.

What is claimed is:

1. A system for pre-selecting a machine learning model based on determined dataset characteristics, the system comprising:
one or more processors executing computer program instructions that, when executed, cause operations comprising:
receiving a time-series dataset, the time-series dataset comprising a set of data points having a relationship between (i) a set of timestamps and (ii) a value associated with a variable;
generating a periodogram based on the time-series dataset to determine power frequencies of a set of frequencies of the time-series dataset, wherein the periodogram is a frequency domain representation of the time-series dataset;
determining an asymptotic p-value of the periodogram based on the power frequencies, wherein the asymptotic p-value of the periodogram indicates a probability value that a seasonal cycle is part of the time-series dataset;
in response to a comparison between the asymptotic p-value and a user-selected threshold p-value indicating that the asymptotic p-value fails to exceed the user-selected threshold value, determining a seasonality cycle of the time-series dataset;
in response to determining the seasonality cycle of the time-series dataset, determining a period associated with the seasonality cycle based on the power frequencies of the time-series dataset; and
generating, for display, on a user interface, a recommendation for a machine learning model of a set of machine learning models based on (i) the seasonality cycle of the time-series dataset, (ii) the power frequencies of the set of frequencies of the time-series dataset, and (iii) the period associated with the seasonality cycle.

2. A method for pre-selecting a machine learning model based on determined dataset characteristics, the method comprising:
receiving a time-series dataset, the time-series dataset comprising a set of data points having a relationship between (i) a set of timestamps and (ii) a value associated with a variable;
generating a periodogram based on the time-series dataset to determine power frequencies of a set of frequencies of the time-series dataset, wherein the periodogram is a frequency domain representation of the time-series dataset;
determining an asymptotic p-value based on the periodogram, wherein the asymptotic p-value of the periodogram indicates a probability value that a seasonal cycle is part of the time-series dataset;
in response to a comparison between the asymptotic p-value and a threshold p-value indicating that the asymptotic p-value exceeds the threshold p-value, determining a seasonality cycle of the time-series dataset, wherein the comparison indicates that the asymptotic p-value fails to exceed the threshold p-value; and
generating, for display, on a user interface, a recommendation for a machine learning model based on (i) the seasonality cycle of the time-series dataset and (ii) the power frequencies of the set of frequencies of the time-series dataset.

3. The method of claim 2, wherein generating the recommendation for the machine learning model further comprises:
in response to determining the seasonality cycle of the time-series dataset, determining a period associated with the seasonality cycle based on the power frequencies of the time-series dataset, wherein the seasonality cycle of the time-series dataset is determined; and
generating the recommendation for the machine learning model further based on the period associated with the seasonality cycle of the time-series dataset.

4. The method of claim 3, further comprising:
identifying, based on the power frequencies of the set of frequencies of the time-series dataset, a subset of power frequencies of the power frequencies, wherein each power frequency of the subset of power frequencies is associated with a power value that is greater than a threshold power value;
determining a set of periods associated with the time-series dataset, wherein each period of the set of periods is associated with (i) a respective power frequency of the subset of power frequencies and (ii) a power value associated with the respective power frequency of the subset of power frequencies; and
determining the period associated with the seasonality cycle by selecting a first period from the set of periods that is associated with a first power value that is greater than that of other power values associated with the set of periods.

5. The method of claim 3, wherein determining the period associated with the seasonality cycle based on the power frequencies of the time-series dataset comprises applying an autocorrelation function to the time-series dataset.

6. The method of claim 5, wherein determining the period associated with the seasonality cycle based on the power frequencies of the time-series dataset further comprises selecting a period from a set of periods resulting from the application of the autocorrelation function that is associated with a first autocorrelation value that is greater than second autocorrelation values associated with other periods from the set of periods resulting from the application of the autocorrelation function.

7. The method of claim 2, wherein generating the periodogram further comprises:
receiving a user selection of a constant trend model; and
generating the periodogram using the constant trend model.

8. The method of claim 2, wherein generating the periodogram further comprises:
receiving a user selection of a linear trend model; and
generating the periodogram using the linear trend model.

9. The method of claim 2, further comprising:
determining, for each power frequency of the set of frequencies, whether a power value associated with a respective power frequency is greater than half of a length associated with the time-series dataset; and
updating the time-series dataset by removing each power frequency that has a power value that is greater than half of the length associated with the time-series dataset.

10. The method of claim 2, wherein determining the asymptotic p-value based on the periodogram further comprises:
receiving a user selection of a spectral decomposition technique using orthonormal functions; and
applying the spectral decomposition technique using orthonormal functions to the generated periodogram.

11. The method of claim 2, wherein generating the periodogram further comprises:
receiving a user selection of Welch periodogram parameters associated with the time-series dataset; and
generating the periodogram using the Welch periodogram parameters, wherein the generated periodogram is a Welch periodogram based on the time-series dataset.

12. The method of claim 2, wherein the threshold p-value is a user-selected threshold p-value.

13. The method of claim 2, wherein generating the recommendation for the machine learning model further comprises:
determining a set of machine learning models configured to receive the time-series dataset using the seasonality cycle of the time-series dataset;
selecting, from the set of machine learning models, a first machine learning model, wherein the first machine learning model corresponds to a period associated with the seasonality cycle of the time-series dataset based on the power frequencies of the set of frequencies of the time-series dataset; and
generating the recommendation for the machine learning model using the selected first machine learning model.

14. The method of claim 2, wherein generating the recommendation for the machine learning model further comprises:
determining a type of seasonality of the time-series dataset based on an optimal residual analysis technique of the time-series dataset, wherein the type of seasonality is a multiplicative type or an additive type;
determining a set of machine learning models configured to receive the time-series dataset using (i) the seasonality cycle of the time-series dataset and (ii) the type of seasonality of the time-series dataset;
selecting, from the set of machine learning models, a first machine learning model, wherein the first machine learning model corresponds to (i) a period associated with the seasonality cycle of the time-series dataset based on the power frequencies of the set of frequencies of the time-series dataset and (ii) the type of seasonality of the time-series dataset; and
generating the recommendation for the machine learning model using the selected first machine learning model.

15. One or more non-transitory computer-readable media storing instructions that, when executed by one or more processors, cause operations comprising:
generating a periodogram based on a time-series dataset to determine power frequencies of a set of frequencies of the time-series dataset;
determining an asymptotic p-value based on the periodogram, wherein the asymptotic p-value of the periodogram indicates a probability value that a seasonal cycle is part of the time-series dataset;
in response to a comparison between the asymptotic p-value and a threshold p-value indicating that the asymptotic p-value fails to exceed the threshold p-value, determining a seasonality cycle of the time-series dataset; and
generating, for display, on a user interface, a recommendation for a machine learning model based on (i) the seasonality cycle of the time-series dataset and (ii) the power frequencies of the set of frequencies of the time-series dataset.

16. The media of claim 15, wherein generating the recommendation for the machine learning model further comprises:
in response to determining the seasonality cycle of the time-series dataset, determining a period associated with the seasonality cycle based on the power frequencies of the time-series dataset; and
generating the recommendation for the machine learning model further based on the period associated with the seasonality cycle of the time-series dataset.

17. The media of claim 16, the instructions further causing operations comprising:
identifying, based on the power frequencies of the set of frequencies of the time-series dataset, a subset of power frequencies of the power frequencies, wherein each power frequency of the subset of power frequencies is associated with a power value that is greater than a threshold power value;
determining a set of periods associated with the time-series dataset, wherein each period of the set of periods is associated with (i) a respective power frequency of the subset of power frequencies and (ii) a power value associated with the respective power frequency of the subset of power frequencies; and
determining the period associated with the seasonality cycle by selecting a first period from the set of periods that is associated with a first power value that is greater than that of other power values associated with the set of periods.

18. The media of claim 16, wherein determining the period associated with the seasonality cycle based on the power frequencies of the time-series dataset comprises applying an autocorrelation function to the time-series dataset.

19. The media of claim 15, wherein generating the recommendation for the machine learning model further comprises:
determining a set of machine learning models configured to receive the time-series dataset using the seasonality cycle of the time-series dataset;
selecting, from the set of machine learning models, a first machine learning model, wherein the first machine learning model corresponds to a period associated with the seasonality cycle of the time-series dataset based on the power frequencies of the set of frequencies of the time-series dataset; and
generating the recommendation for the machine learning model using the selected first machine learning model.

20. The media of claim 15, wherein generating the recommendation for the machine learning model further comprises:
determining a type of seasonality of the time-series dataset based on an optimal residual analysis technique of the time-series dataset, wherein the type of seasonality is a multiplicative type or an additive type;
determining a set of machine learning models configured to receive the time-series dataset using (i) the seasonality cycle of the time-series dataset and (ii) the type of seasonality of the time-series dataset;
selecting, from the set of machine learning models, a first machine learning model, wherein the first machine learning model corresponds to (i) a period associated with the seasonality cycle of the time-series dataset based on the power frequencies of the set of frequencies of the time-series dataset and (ii) the type of seasonality of the time-series dataset; and
generating the recommendation for the machine learning model using the selected first machine learning model.
